(19) United States
(12) Patent Application Publication
(10) Pub. No.: US 2007/0282458 A1
(43) Pub. Date: Dec. 6, 2007

(54) CONTROL APPARATUS, CONTROL METHOD AND MONITORING CONTROL SYSTEM

(76) Inventors: Takahiro Yamada, Mito (JP); Atsushi Nishioka, Hitachi (JP); Yoshio Maruyama, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/753,810

(22) Filed: May 25, 2007

(30) Foreign Application Priority Data
May 30, 2006 (JP) 2006-150199
Sep. 14, 2006 (JP) 2006-249508

(51) Int. Cl. G05B 19/18; G05B 13/02; G06F 17/00

(52) U.S. Cl. 700/2; 700/90; 700/28

(57) ABSTRACT

A control device includes a CPU generating a control instruction for a control apparatus according to an instruction inputted from an OPS or a server and a radio communication unit performing a radio communication with each of the control apparatuses and measurement apparatuses. The control and the measurement apparatuses include a radio communication unit for performing a radio communication with the control device and other control and the measurement apparatus, and an operation circuit for performing a control and protection operation process. The operation circuit operates and controls a control signal according to a control instruction inputted from the control device, logic of the protection interlock and the control logic stored in the operation circuit, and process data on the control apparatus and other associated control and measurement apparatus, thereby monitoring and controlling a plant.

### INCORPORATION BY REFERENCE

The present application claims priorities from Japanese applications JP2006-150199 filed on May 30, 2006, JP2006-249508 filed on Sep. 14, 2006, the contents of which are hereby incorporated by reference into this application.

### BACKGROUND OF THE INVENTION

The present invention relates to a monitoring control system or the like for operating a plant by monitoring and controlling a control apparatus and in particular, to a monitoring control system appropriate for monitoring and controlling various control apparatuses in a water power generation, steam power generation, and atomic power generation plant and a control apparatus and a control method used in the system.

In a generation plant, computers such as an operation device and a server are arranged in a central control room and these are connected to control devices such as a main turbine control device and a boiler local control device via a network so as to constitute a system for operating various control apparatuses according to an operation instruction from the operation device or a control instruction from the control device. The operation device is a human-machine interface device having operation and monitoring functions required for operation of the plant, outputs an instruction for each control apparatus to the control device according to a request of an operator, and displays plant information on a display device such as a display so as to provide various control information and guidance. The server performs information processing associated with operation of the entire plant and generates an operation instruction, a stop instruction, and the like for each control device.

The control device includes a process I/O device for outputting instructions such as start and stop or adjustment of a control amount to various control apparatuses according to the operation instruction from the operation device and instructions of operation, stop, and the like generated by the server and inputting a sensor detection value measured by a measuring device. The process I/O device is connected by cables to various control apparatuses including valves such as an electric valve, an electromagnetic valve, and the like, a pump, a motor, an actuator, and the like. Even in a small-scale generation plant, the number of cables reaches several tens of thousands, which occupy a significant part of the construction cost.

Recently, in order to reduce the construction cost, a method for connecting the control device to the control apparatus by a field bus instead of cables for transmission is used. According to a certain field bus standard, one cable (segment) can transmit bi-directional signals of 32 control apparatus and measurement apparatuses and it is possible to significantly reduce the number of cables as compared to the process I/O method of the conventional method using cables. By reduction of the number of cables, it is possible not only to reduce the cable arrangement cost but also reduce the number of I/O devices built in the control device. This reduces the size of the control device and simplifies the configuration of the central control room.

Moreover, there is a monitoring control system capable of reducing the number of cables to be installed and simplifying the device configuration by connecting to a control device, a power board switch device for outputting a control instruction to a plurality of control apparatuses and inputting information on the states of the plurality of control apparatuses.

JP-A-10-164775 discloses an example of a monitoring control system in which a control device is connected to a power-board switch device via a serial cable and the power-board switch device monitors and controls a plurality of control apparatuses.

### SUMMARY OF THE INVENTION

In the field bus method of the aforementioned related art, a control device is connected to control apparatuses by a field bus so as to reduce the number of cables as compared to the process I/O method. However, in the case of the field bus, there is a problem that if a trouble such as disconnection occurs at a certain point of a segment, all the transmissions to the control apparatuses and measurement apparatuses connected to the downstream side (apparatus side) from the disconnected point are disabled. For this, in the plant such as a power station, this method is not used for an important control system from the viewpoint of necessity of the reliability and stable supply. Accordingly, even in a large-scale steam-power generation station using tens of thousands of I/O points, the field bus can be applied only for systems of less importance and cannot significantly reduce the number of cables.

Moreover, since the conventional control apparatus does not have means for performing a complicated process, control and protection logic of each control apparatus is defined at the control device side for performing operation. Furthermore, in the conventional field bus method, the number of control apparatuses and measurement apparatuses which can be connected to one segment is limited to a certain number and only a small number of signals can be transmitted and received between one control apparatus to/from the control device and other control apparatus. For this, a protection interlock condition required for control and protection logic of a certain control apparatus may belong to other segment. In this case, information should be acquired via the control device. Accordingly, the control apparatus side can realize only a simple logic and main control and protection logic of the control apparatus should be arranged in the control device side. Thus, the control device cannot be made into an autonomous distributed type.

JP-A-10-164775 discloses a monitoring control system in which a power-board switch device and a control apparatus are connected by a process cable and a large number of cables are required. Moreover, information on control, protection logic, and protection interlock condition required for them are defined at the power-board switch device side and information on a control instruction based on the monitor information on the protection interlock is processed and generated at the power-board switch device side. Thus, the protection interlock is autonomous and distributed. However, the autonomous distributed degree is such that control cannot be performed without an instruction from the control device. Furthermore, since the control device is connected to each power-board switch devise by a serial transmission cable using the cascade connection, if a disconnection occurs at a certain point of the serial transmission cable or the power-board switching device fails, all the transmissions between the power-board switch device connected at the downstream side (power-board switch device side) from the disconnection or the failure point and the control device are disabled.

Furthermore, recently, with increase of the plant scale and the sophistication of the control system, the number of I/O parts of the control device tends to increase, which in turn increase the installation cost. A system easily compatible with extension of a device and an apparatus is desired.

It is therefore an object of the present invention to provide an autonomous distributed monitoring control system not using cables between a control device and control/measurement apparatuses and performing control and protection calculation at the control/measurement apparatus side.

The present invention includes: a radio communication unit for performing radio communication with a control device, other control apparatus, and a measurement apparatus; and an operation circuit performing a control and protection operation processing in control apparatuses such as a valve, a pump, a motor, and an actuator and a measurement apparatus. Moreover, the operation circuit has a state input unit for inputting process data indicating the state of a control apparatus and a measurement value of a measurement apparatus, a radio control information I/O unit for inputting or outputting control information such as a control instruction and process data via the radio communication unit, a storage unit for storing the protection interlock of the control apparatus or the logic of the control logic, an operation unit for operating the control signal according to the control instruction from the control device and the process data on the control apparatus and other associated control apparatus, and a control signal output unit for outputting the control signal operated by the operation unit to the control apparatus.

Thus, by arranging an operation circuit in the control apparatus and the measurement apparatus to make them programmable, it is possible to build in the logic of the protection interlock or the control logic. Moreover, by transmitting and receiving the other control apparatus state and measurement data required for the logic without using the control device, it is possible to continue sufficient control only by the control apparatus side even if the radio communication with the control device is disconnected.

When constituting the control and measurement apparatuses, it is preferable that at least one of the state input unit, the control signal output unit, and the operation unit be multiplexed.

Furthermore, by arranging a relay function in each radio communication unit of the control and the measurement apparatus, even if a part of the communication route is disconnected, it is possible to perform communication by detour via other route.

Moreover, in the present invention, a radio communication unit for performing radio communication between the control and the measurement apparatus is mounted on the control device and a radio LAN (Local Area Network) is formed between a plurality of control devices and a plurality of control and measurement apparatuses, thereby constituting a monitoring control system for operating a plant.

Moreover, the logic (logic program) of the protection interlock or the control logic to be built in the control apparatus is made rewritable and a maintenance device is provided for performing maintenance including logic program loading, parameter tuning, and data simulation. The maintenance device includes a radio communication unit for performing radio communication between the control and the measurement apparatus and by performing radio communication between the maintenance device and the control/measurement apparatus, it is possible to realize maintenance of the logic program to be built in the control apparatus.

Moreover, the control apparatuses such as the valve, the pump, the motor, and the actuator, and the measurement apparatus include: a power line communication unit for performing communication with the control device and other control apparatus and the measurement apparatus by the power line communication by using the power line for supplying power as a transmission path for information communication; and an operation circuit for performing a control and a protection operation process. Moreover, the operation circuit includes: a state input unit for inputting process data indicating the control apparatus state and a measurement value of a measurement apparatus; a control information I/O unit for inputting or outputting control information such as a control instruction and process data via the power line communication unit; a storage unit for storing the logic of the protection interlock or the control logic of the control apparatus; an operation unit for operating a control signal according to the protection interlock or the logic of the control logic stored in the storage unit, a control instruction from the control device, and process data on the control apparatus and the other associated control apparatus; and a control signal output unit for outputting the control signal operated by the operation unit to the control apparatus.

Thus, it is possible to provide an operation circuit in the control apparatus and the measurement apparatus to make them programmable and build in the logic of the protection interlock or the control logic. Moreover, by transmitting and receiving information such as the other control apparatus state and measurement data required for the logic without using the control device, the control apparatus itself can perform an urgent operation such as the protection interlock independently of the control device. For this, even if the power line communication unit of the control device has failed and the power line communication between the control device and the control apparatus is disconnected, the control apparatus itself can perform operation associated with the protection interlock and control and it is possible to eliminate hazard. Moreover, when the plant is performing a constant operation, the control apparatus side alone can continue sufficient control.

It should be noted that when constituting the control and the measurement apparatus, it is preferable that at least one of the state input unit and the control signal output unit be multiplexed.

Moreover, in this invention, the control device includes a power line communication unit for performing power line communication between the control and the measurement apparatus and LAN (Local Area Network) is established between a plurality of control devices and a plurality of control/measurement apparatuses so as to monitor/control the control/measurement apparatuses, there by constituting a monitoring control system for operating a plant.

Moreover, the protection interlock or the logic (logic program) of the control logic to be built in the control apparatus are made rewritable and a maintenance device is provided for performing maintenance including loading of the logic program, parameter tuning, and data simulation. The maintenance device includes a power line communication unit for performing power line communication between the control and the measurement apparatuses. By performing power line communication between the maintenance device, the control/measurement apparatuses, it is possible to realize maintenance of the logic program to be built in the control apparatus.

According to the present invention, it is possible to obtain a cable-less configuration by making connection between the control/measurement apparatuses and the control device without using a cable. Accordingly, it is possible to reduce the facility size, simplify the facility configuration, and reduce the plant construction cost. Moreover, since connections between the respective control/measurement apparatuses and the control device are made by a network performing radio communication, a disconnection at a point may not affect the other apparatuses as the field bus and it is possible to improve the reliability.

Moreover, each control/measurement apparatus includes an operation circuit to become programmable and the protection interlock or the control logic is built in so as to obtain an autonomous distributed system. Accordingly, even if the radio communication with the control device is cut off, it is possible to continue stable control. Furthermore, since each control and measurement apparatus has the radio communication relay function, even if a part of the communication route is cut off, it is possible to obtain other detour route to perform communication, thereby preventing communication failure.

Moreover, by performing communication by using a power cable connecting the control/measurement apparatus to the control device, it is possible to obtain a configuration eliminate the need of a cable other than the power cable. Accordingly, it is possible to reduce the facility size, simplify the facility, and reduce the plant construction cost. Moreover, it is possible to perform stable communication as compared to the radio communication.

Moreover, each control/measurement apparatus includes an operation circuit to become programmable and the protection interlock or the control logic is built in so as to obtain an autonomous distributed system. Accordingly, even if the radio communication with the control device is cut off, it is possible to continue stable control.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example of the entire configuration of a monitoring control system according to an embodiment of the present invention.

FIG. 2 is a block diagram showing a configuration example of a control apparatus according to the embodiment of the present invention.

FIG. 3 is a block diagram showing a configuration example of a measurement apparatus according to the embodiment of the present invention.

FIG. 4 is a block diagram showing an example of the entire configuration of a monitoring control system according to another embodiment of the present invention.

FIG. 5 is a block diagram showing a configuration example of an electric valve according to the another embodiment of the present invention.

FIG. 6 is a block diagram showing a configuration example of a measurement apparatus according to the another embodiment of the present invention.

### DETAILED DESCRIPTION OF THE EMBODIMENTS

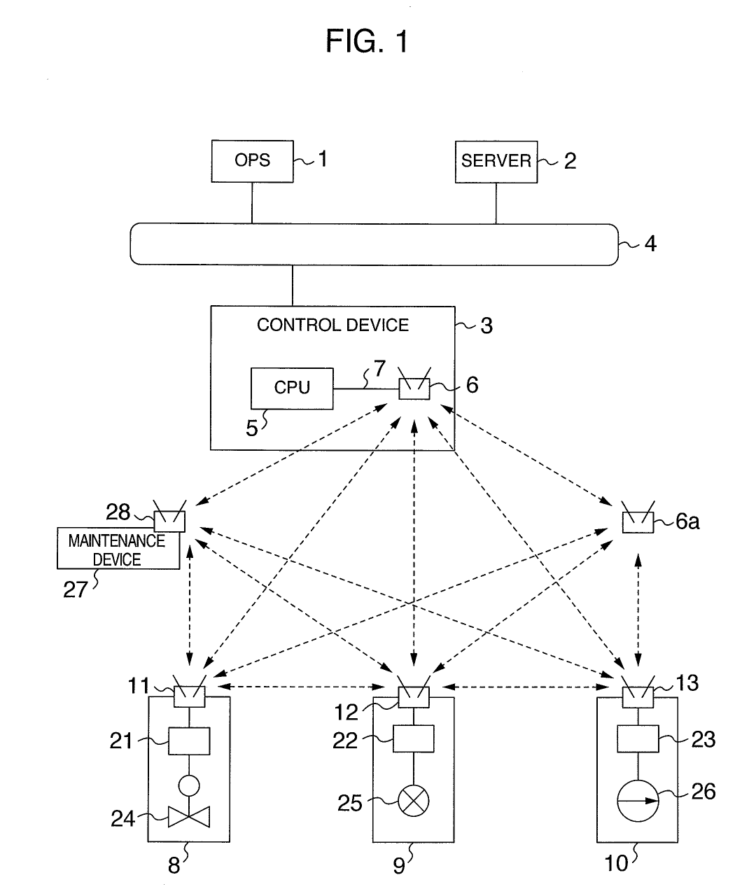

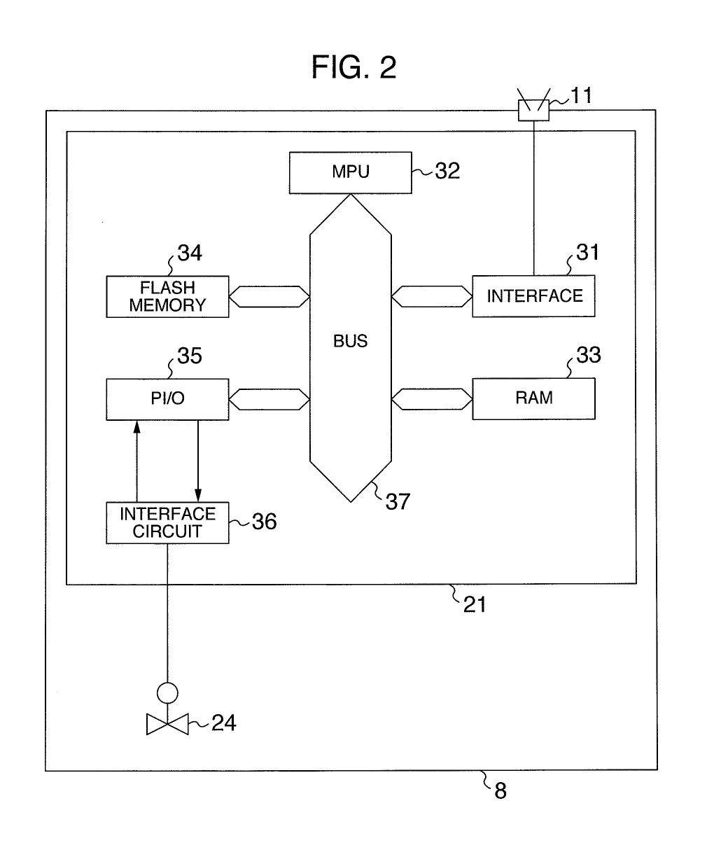

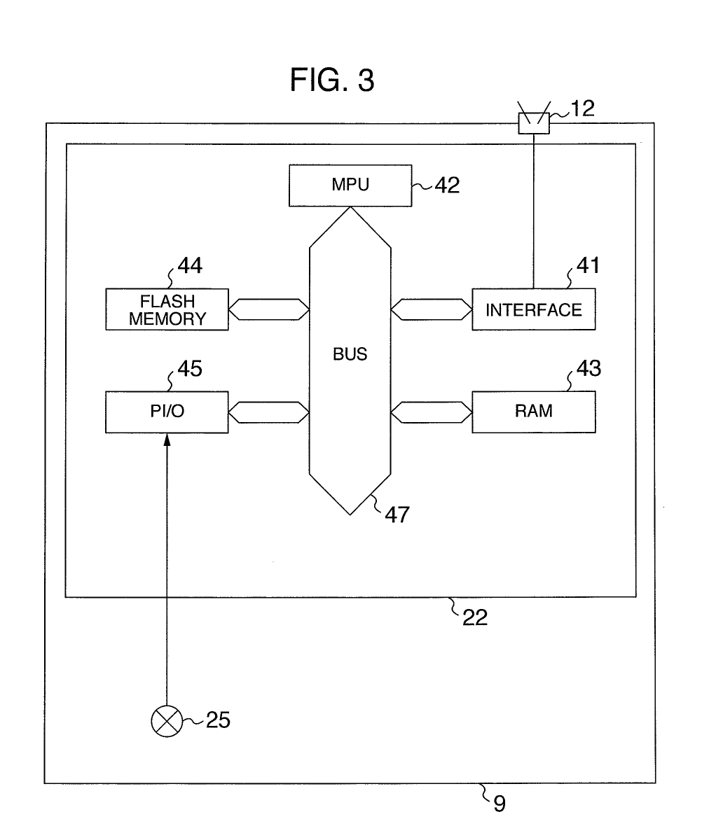

Description will now be directed to an embodiment of the present invention with reference to the attached drawings. FIG. 1 is a block diagram showing an example of the entire configuration of a system according to an embodiment of the present invention. FIG. 2 is a block diagram showing an electric valve as an example of a control apparatus. FIG. 3 is a block diagram showing a configuration example of a sensor having a built-in operator as an example of a measurement apparatus.

Firstly, referring to FIG. 1, explanation will be given on the entire configuration of the system according to the first embodiment of the present invention. The system includes an operation device (hereinafter, referred to as OPS) 1, a server 2, a control device 3, a control apparatus, and a measurement apparatus. The OPS 1, the server 2, and the control device 3 are arranged in a central control room and they are connected to one another via a network 4. In general, a plurality of sets of the control device 3 are installed for each control system. However, in FIG. 1, only one set is shown. The OPS 1 is a human-machine interface device having an operation/monitoring function required for operation of the plant. The OPS 1 outputs an instruction to each control apparatus according to a request by an operator, displays plant information on a display device such as a CRT, provides various control information to the operator, and outputs a guidance. The server 2 performs information processing concerning operation of the entire plant and outputs an instruction such as an operation and a stop to the control device 3. The control device 3 inputs an instruction from the OPS 1 or the server 2 via the network 4 and outputs it to a control and a measurement apparatus. It should be noted that the OPS 1 and the server 2 are installed only when they are required.

Next, explanation will be given on the configuration of the control device 3. The control device 3 includes a CPU (Central Processing Unit) 5 and a radio transmission/reception apparatus 6. The CPU 5 is connected to the radio transmission/reception apparatus 6 via a transmission path 7. The CPU 5 is connected to the network 4, processes an instruction inputted from the OPS 1 or the server 2 to generate a control instruction to a plurality of control apparatuses for output, collects information from each control apparatus and a measurement apparatus via the radio transmission/reception apparatus 6, and transmits it to the server 2. The radio transmission/reception apparatus 6 performs radio communication such as outputting the control instruction generated by the CPU 5 to each control apparatus and inputting data outputted from each control apparatus and a measurement apparatus. It is possible to install a plurality of the radio transmission/reception apparatuses 6 and they may be installed apart from the control device 3 such as the radio transmission/reception apparatus 6a. For example, when the control apparatuses and the measurement apparatuses are installed on a plurality of floors or when the control and the measurement apparatuses are installed in a large field, they may be arranged according to the installation environment.

The control and the measurement apparatuses are installed in a job site and operate apparatuses such as an electric valve and a pump according to a control instruction from the control device 3 and output information such as process data indicating the control apparatus state and a measurement value of the measurement apparatus to the control device 3 and the other control and the measurement apparatus. FIG. 1 shows an electric valve 8 and a pump 10 as examples of the control apparatuses and a measurement unit 9 as the measurement apparatuses.

Next, explanation will be given on the configuration of the control and measurement apparatus. The electric valve 8 is formed by a radio transmission/reception apparatus 11 for performing radio communication with the control device 3 and the other control and measurement apparatus, an operation circuit 21 for performing protection or control operation, and an electric valve body 24. Similarly, the pump 10 is formed by the radio transmission/reception apparatus 13, the operation circuit 23, and the pump body 26. The measurement apparatus 9 is also formed by the radio transmission/reception apparatus 12, an operation circuit 22, and a sensor 25. The operation device 22 performs processes such as conversion and correction of a measurement value obtained by the sensor 25. The radio transmission/reception apparatuses (11, 12, 13) arranged in the respective control and measurement apparatuses perform transmission of the control instruction and the process data by radio communication between the control device 3 and the radio transmission/reception apparatus 6 and between the radio transmission/reception apparatuses of the respective control and measurement apparatuses.

Moreover, this embodiment may provide a maintenance device 27 for modifying information such as control logic and internal parameters stored in the operation circuit of the control and measurement apparatus. The maintenance device 27 may be formed by a personal computer or a mobile information terminal having a built-in maintenance function and a radio transmission/reception apparatus 28. By communicating with the control and measurement apparatus as maintenance objects via the radio transmission/reception apparatus 28, it is possible to rewrite information such as the control logic and the internal parameter stored in the operation circuit. Moreover, the maintenance such as the internal parameter tuning and the data simulation can also be performed via the radio transmission/reception apparatus.

Next, referring to FIG. 2, explanation will be further given on the configuration of the control apparatus. FIG. 2 shows the internal configuration of the electric valve 8. The electric valve 8 is formed by an electric valve body (motor and valve) 24, a radio transmission/reception apparatus 11, and an operation circuit 21. The operation circuit 21 includes an interface 31 performing a data I/O process by the radio transmission/reception apparatus 11, an MPU (microprocessor unit) 32 performing protection or control operation, a RAM (random access memory) 33, a flash memory 34, and a process I/O circuit (PI/O) 35 which are connected by a BUS. Moreover, if necessary, the process I/O circuit 35 includes a built-in interface circuit 36. It should be noted that the aforementioned operation circuit 21 is packaged and can easily be mounted on an ordinary installed electric valve.

The electric valve 8 receives a control instruction and process data from the control device 3 or other control apparatus or a measurement apparatus via the radio transmission/reception apparatus 11. Moreover, the process I/O circuit 35 inputs signals such as the flow rate, the valve open degree, and the limit switch which are the process data associated with the electric valve from the electric valve body 24. The nonvolatile flash memory 34 contains protection interlock or the control logic associated with the electric valve. The MPU 32 operates a control instruction according to a control instruction from the control device 3 inputted via the radio transmission/reception apparatus 11 and the interface 31, process data from other control and measurement apparatus and information obtained from the process I/O circuit 35, and logic stored in the flash memory 34, and outputs the control instruction via the process I/O circuit 35 to the electric valve body 24. When a strong electricity is required for driving the electric valve body 24, the interface circuit 36 converts the weak electricity output of the process I/O circuit 35 into the electric signal required for driving the electric valve body 24. In the case of the digital signal conversion, the interface circuit 36 is formed by an element such as a photo MOS relay and an auxiliary relay. In the case of the analog signal conversion, the interface circuit 36 is formed by an isolator and a current amplifier.

Moreover, the MPU 32 inputs process data associated with the electric valve from the electric valve body 24 via the interface circuit 36 and the process I/O circuit 35 and performs a conversion process according to the internal variable stored in the flash memory 34. The process data processed by the MPU 32 is outputted via the interface 31 and the radio transmission/reception apparatus 11 to the control device 33 or other control apparatus and a measurement apparatus.

The logic stored in the flash memory 34 includes a logic used when the radio communication with the control device 3 is disconnected or a logic used when a condition from other control apparatus or measurement apparatus cannot be inputted. For example, when the communication with the control device 3 is disconnected for a certain time, a logic for holding the instruction value from the control device 3 is established. When process data from the other control and measurement apparatus is not inputted, the data inputted immediately before is held for performing an operation process. Thus, even when the radio communication is disconnected, it is possible to prevent control-disabling of the control apparatus and continue the plant operation.

The other control apparatus such as the pump 10 can have almost the same configuration as the electric valve 8. The pump 10 can be similarly configured only by replacing the electric valve body 24 by the pump body (pump and electromagnetic contact) 26.

Next, referring to FIG. 3, explanation will be given on the configuration of the measurement apparatus. FIG. 3 shows the internal configuration of the measurement unit 9. The measurement unit 9 is formed by a radio transmission/reception apparatus 12, an operation circuit 22, and a sensor 25. The operation circuit 22 is similar to the operation circuit 21 of the electric valve 21 and includes an interface 41 for performing a data I/O process by the radio transmission/reception apparatus 12, an MPU 42 for performing an operation such as conversion and correction of a measurement value a RAM 43, a flash memory 44, and a process I/O circuit (PI/O) 45 which are connected by a BUS 47. The process I/O circuit 45 only performs input from the sensor 25 and does not perform output to the sensor 25. Moreover, the measurement unit 9 does not have the interface circuit which is provided in the control apparatus. The aforementioned operation circuit 22 is packaged and can easily be mounted on an installed sensor.

The MPU 42 can perform operations such as engineering value conversion and temperature pressure correction of the sensor measurement value and its operation program is stored in the nonvolatile flash memory 44. The MPU 42 subjects the sensor measurement value inputted from the process I/O circuit 45 to an operation process based on the operation program stored in the flash memory and transmits the result via the radio transmission/reception apparatus 112 to the control device 3 or other control apparatuses 8, 10 and the like.

Thus, in this embodiment, when the control device 3 outputs a control instruction, the instruction is transmitted via the radio transmission/reception apparatus 6 of the control device 3 to the control and measurement apparatuses 8 to 10 as operation objects by radio communication. Accordingly, there is no need of connecting the control device 3 to the control and measurement apparatuses 8-10 by cables. This simplifies the configuration of the device.

Moreover, each of the control apparatuses (electric valve, pump, actuator, and the like) has a built-in protection or control logic and can autonomously obtain external conditions required for operation without using the control device 3. Accordingly, instructions passed between the control device 3 and the respective control apparatuses are mainly start and stop instructions, or a control amount adjustment instruction. For this, even if the radio communication between the control device 3 and the respective control apparatuses is disconnected, no trouble occurs for operation. Especially when the plant is performing a constant operation, it is possible to continue stable operation for a certain time. Furthermore, the control apparatus can have a built-in protection logic used when the radio communication between the control device 3 and other control and measurement apparatus is disconnected. Accordingly, eve if a part of the radio communication is disconnected and a trouble is generated in the control apparatus, the plant will not fail.

Next, explanation will be given on the maintenance method of operation programs such as a protection logic or a control logic built in the control apparatus of the present embodiment and a conversion process built in the measurement apparatus.

As shown in FIG. 1, in this embodiment, a radio transmission/reception apparatus 28 is arranged in a maintenance device 27 having a built-in maintenance function in a personal computer and a computer of a mobile information terminal so as to perform control of the maintenance object and communication with the measurement apparatus, thereby modifying information such as the control logic and the internal parameter. The maintenance device 27 may be installed at a location capable of performing radio communication with an apparatus as the maintenance object if necessary. A maintenance staff can perform the maintenance work at a place where the work can be easily performed such as the central control room or in the vicinity of the control and the measurement apparatus in the site.

The maintenance device 27 contains operation programs of the protection interlock or the control logic built in the control apparatuses such as the electric valve 8 and the pump 10 and the engineering value conversion and the temperature pressure correction built in the measurement apparatus such as the measurement unit 9. During a maintenance, the logic, the operation program, the parameter which should be modified are modified by the maintenance device 27 and the modification contents are transmitted via the radio transmission/reception apparatus 28 to an object apparatus, so as to rewrite the contents of the flash memory in the operation circuit of the object apparatus. Moreover, by providing the tuning function and data simulation function of the internal parameter used in the logic and operation of the control and measurement apparatus in the maintenance device 27, it is possible to perform the internal parameter tuning and the data simulation work via the radio transmission/reception apparatus 28.

Thus, in this embodiment, the operation programs associated with the protection interlock or the control logic and the measurement value correction are distributed in the operation circuits arranged in the control and measurement apparatus but their maintenance may be performed at once by the maintenance device having the radio transmission/reception apparatus. Moreover, since the maintenance device need not be arranged in the fixed manner, it is possible to perform the maintenance work at an arbitrary location where communication is enabled when necessary.

Next, explanation will be given on the radio communication process of the control device and the control and measurement apparatus. The control device and the control and measurement apparatus of the present embodiment have a function for receiving and transmitting data not required for their logic operation in addition to the I/O data of themselves.

Explanation will be given on an example of a radio communication process in the present embodiment. In this embodiment, a plurality of sets of control device are set for each control system. One control device performs radio communication with a plurality of control and measurement apparatuses to be monitored and controlled by the control device. Moreover, the control and the measurement apparatus also performs radio communication with the control device and other control and measurement apparatus in the control system to which the apparatus belongs. In a radio communication process in one control system, a radio transmission field defining arrangement of all the transmission data is used for transmitting and receiving the entire radio transmission field during radio communication between the control device and each control and measurement device. The transmission/reception process is performed by the radio communication interface. When data is received, the data in the radio transmission field is stored in the internal storage region of the interface arranged in the logical circuit. When data is transmitted, predetermined data on the radio transmission field is rewritten and the entire transmission field is transmitted.

Thus, the radio transmission field is treated as a virtual common memory and all the nodes performs a transmission process by the autonomous distributed protocol for copying the virtual memory, thereby realizing the data relay function.

Moreover, in this embodiment, since each control apparatus and each measurement apparatus have the data relay function, a communication may be continued by detour through other route even if a part of the communication route is cut. For example, when the data measured by the measurement unit 9 is used as a condition of the logic operation of the electric valve 8, if radio communication between the electric valve 8 and the measuring unit 9 or between the control device 3 and the measurement unit 9 is disabled, the electric valve 8 cannot be normally controlled. However, in this embodiment, data from the measurement unit 9 may be, for example, transmitted via the pump 10 to the electric valve 8. Thus, even if a communication defect occurs partially, control of the electric valve can be continued.

Furthermore, in this embodiment, when a new control apparatus or a new measurement apparatus is to be added, it can easily be added to the system without installing a process I/O cable. When a newly added control apparatus uses process data in the existing control apparatus or the existing measurement apparatus for an operation process and an interlock condition, the transmission process cab be performed by the aforementioned autonomous distributed protocol. Thus, the data can be obtained without reforming the existing control apparatus or the measurement apparatus.

It should be noted that it is preferable that the radio transmission be multiplexed by modifying the frequency band and the relay station installation position.

As has been described above, by configuring the control device and the respective control apparatuses and the measurement apparatuses as the radio LAN, i.e., a cable-less configuration, it is possible to significantly reduce the number and amount of cables and simplify the device. Moreover, each of the control and measurement apparatuses is made programmable and the protection interlock or the control logic is built inside to realize an autonomous distributed system. Accordingly, even if the radio communication with the control device is disconnected, it is possible to continue the control without causing an accident. Furthermore, since each of the control apparatuses and each of the measurement apparatuses have the relay function, the communication can be continued by detour through other route even if one communication route is partially disconnected.

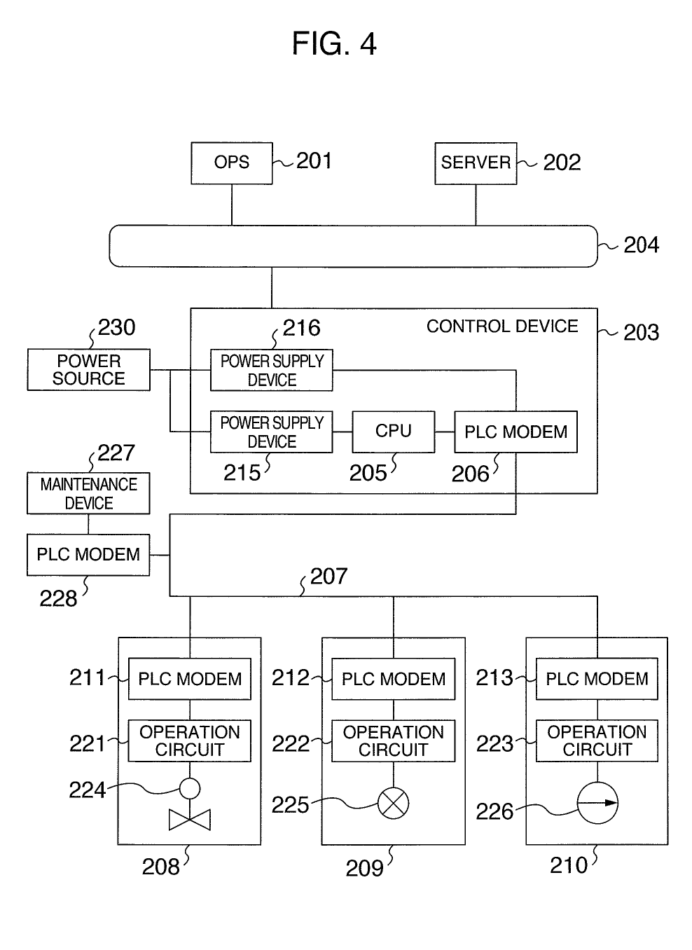

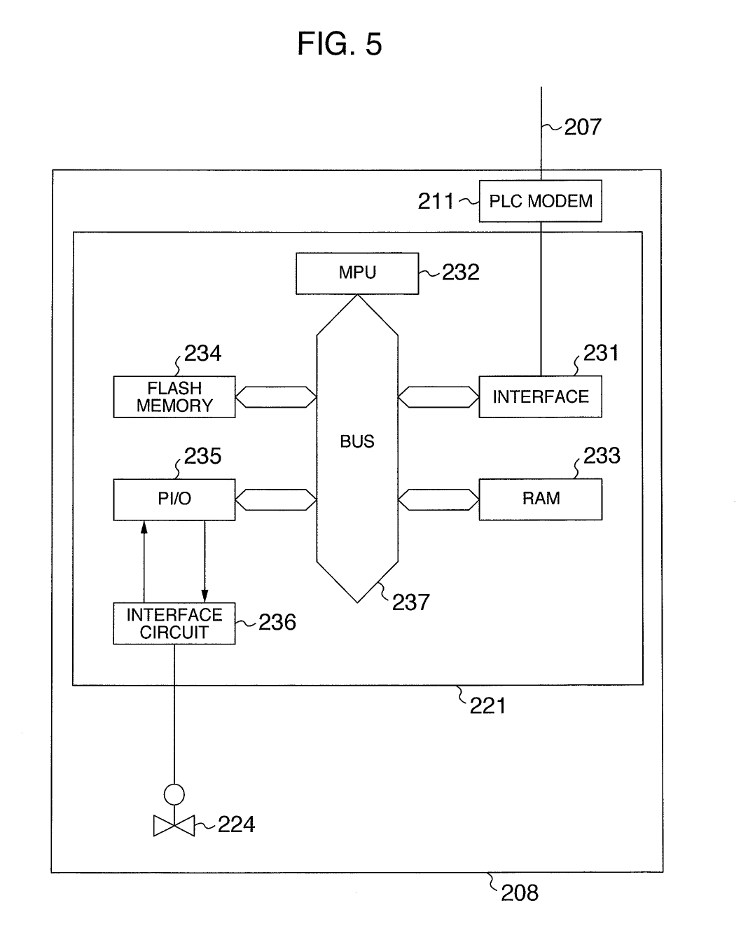

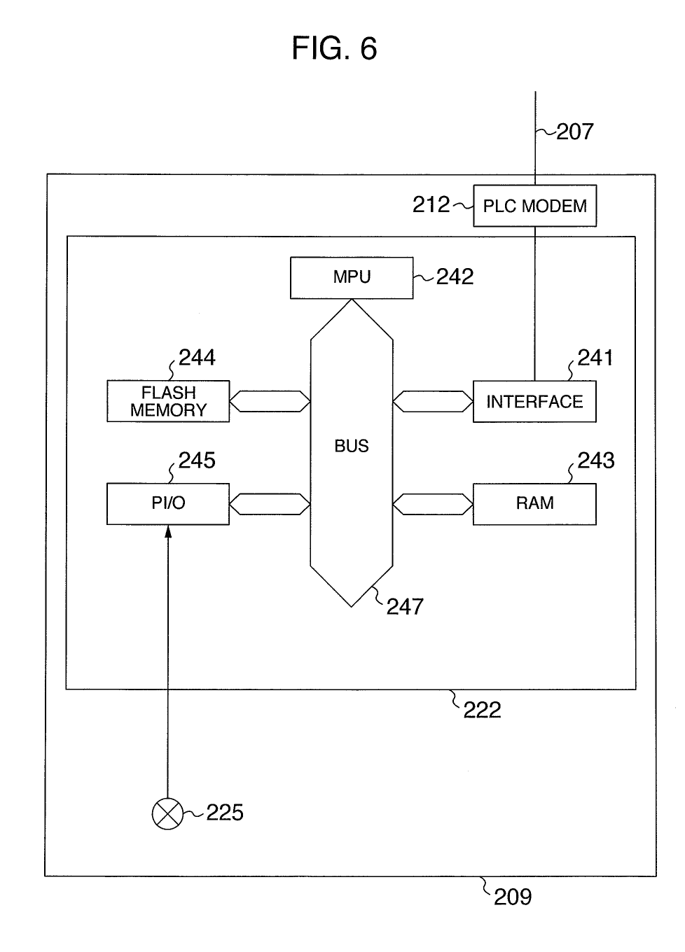

Next, explanation will be given a second embodiment. FIG. 4 shows the entire configuration of the system according to the second embodiment of the present invention. FIG. 5 is a block diagram showing an electric valve as an example of the control apparatus. FIG. 6 is a block diagram showing a configuration example of a sensor having a built-in operator as an example of the measurement apparatus.

Referring to FIG. 4, explanation will be given on the entire configuration example of the system according to the second embodiment. This embodiment includes an operation device (hereinafter, referred to OPS) 201, a server 202, a control device 203, a control apparatus, and a measurement apparatus. The OPS 201, the server 202, and the control device 203 are installed in the central control room or the like and they are connected to one another via a network 204. In general, a plurality of sets of the control device 203 are installed for each control system but in FIG. 4, only one set 201 is shown. The OPS 201 is a human-machine interface device having the operation/monitoring function required for operation of the plant. The OPS 201 outputs an instruction for each control apparatus to the control device 203 according to a request from an operator, displays plant information to a display device such as a CRT, provides various types of control information to the operator, and outputs guidance. The server 202 performs information processing associated with the operation of the entire plant and outputs an instruction such as operation and stop for the control device 203. The control device 203 inputs the instruction from the OPS 201 or the server 202 via the network 204 and outputs it to the control or the measurement apparatus. It should be noted that the OPS 201 and the server 202 are installed if necessary and can be eliminated if not necessary.

Next, explanation will be given on the configuration of the control device 203. The control device 203 includes: a CPU (Central Processing Unit) 205 as a processing unit for generating a control instruction for the control apparatus, monitoring and controlling the control apparatus; and a PLC (Power Line Communication) modem 206 as a power line communication unit. The PLC modem 206 is connected to the power line 207. The CPU 205 is connected to the network 4, processes an instruction inputted from the OPS 201 or the server 202 and generates a control instruction for a plurality of control apparatuses for output. Moreover, the CPU 205 collects information from the respective control apparatuses and the measurement apparatuses and transmit it to the server 202 and the like. The PLC modem 206 performs information I/O processing by the power line communication. That is, the PLC modem 206 superimposes the control instruction generated by the CPU 205 on the power line 207 for output to the respective control apparatuses, receives data outputted from the respective control apparatuses and the measurement apparatuses while being superimposed on the power line 207, isolates the data, and inputs the data to the CPU 205. The power line communication superimposes a carrier on the power line and performs modulation by the data on the carrier to be superimposed, thereby performing data communication. The reception side demodulates the carrier to obtain the data. It should be noted that in this embodiment, the control device 203 receives power from a power source 230. A power supply device 215 and a power supply device 216 convert supplied voltage and supply the power to the CPU 205 and the PLC modem 206. Furthermore, the control device 203 supplies the power supplied from the power source 230 to the control apparatuses and the measurement apparatuses by the power line 207.

Thus, the power line 207 supplies power from the control device 203 to the respective control apparatuses and measurement apparatuses and is also used as a transmission path for data communication. Alternatively, as a power supply method, it is also considered that the control device 203 and the respective control apparatuses and measurement apparatuses use separate power systems. Here, communication between the control device 203 and the respective control apparatuses and measurement apparatuses may be performed by collecting information from the respective control apparatuses and the measurement apparatuses to one position by the power line communication and from there communication with the control device 203 is performed.

The control apparatuses and the measurement apparatuses are installed in the site for operating an apparatus such as an electric valve and a pump according to a control instruction from the control device 203 and outputting process data indicating the control apparatus state and a measurement value of the measurement apparatus to the control device 203 and other control and measurement apparatus. FIG. 4 shows an electric valve 208 and a pump 210 as examples of the control apparatus and a measurement unit 9 as an example of the measurement apparatus.

Next, explanation will be given on configuration of the control and the measurement apparatus. The electric valve 208 includes: a PLC modem 211 as a power line communication unit for performing power line communication with the control device 203 and other control apparatus and measurement apparatus; an operation circuit 221 for performing protection or control operation; and an electric valve body 224. Similarly, the pump 210 includes a PLC modem 213, an operation circuit 223, and a pump body 226. Similarly, the measurement unit 209 includes a PLC modem 212, an operation circuit 222, and a sensor 225. The operation circuit 222 performs conversion and correction of the measurement value obtained by the sensor 225. Moreover, the PLC modems 211, 212, 213 arranged on the respective control apparatuses and measurement apparatus make a connection with the PLC modem 206 of the control device 203 and the PLC modems of the respective control and measurement apparatus via the power line 207 and transmit and receive information such as a control instruction and the process data by the power line communication.

Moreover, in this embodiment, it is possible to provide a maintenance device 227 for modifying information such as a control logic and an internal parameter stored in the operation circuit of the control and the measurement apparatus. The maintenance device 227 may be formed by a computer having a built-in maintenance function in a personal computer or a mobile information terminal and a PLC modem 228. By making a connection to the power line 207 via the PLC modem 228 and performing power line communication with the control and measurement apparatus to be subjected to maintenance, it is possible to rewrite information such as the control logic and the internal parameter stored in the operation circuit. Similarly, the maintenance such as the internal parameter tuning and data simulation may also be carried out by the power line communication.

Next, referring to FIG. 5, further explanation will be given on the configuration of the control apparatus. FIG. 5 shows the internal configuration of the electric valve 208. The electric valve 208 includes a PLC modem 211, an operation circuit 221, and an electric valve body (motor and valve) 224. The operation circuit 221 is formed by an interface 231 as a control information I/O unit for performing an I/O process of control information by the PLC modem 211, an MPU (Micro Processing Unit) 232 as an operation unit for performing protection or control operation, a RAM (Random Access Memory) 233, a flash memory 234 as a storage unit for storing logic such as a protection interlock or a control logic, and a process I/O circuit (PI/O) 235 as a state input unit for inputting information such as process data indicating the state of the control apparatus and as a control signal output unit for outputting the control signal operated by the MPU 232 which are connected by a bus 237. Moreover, if necessary, the process I/O circuit 235 includes a built-in interface circuit 236. It should be noted that the operation circuit 221 is packaged and can easily be mounted on the ordinary installed electric valve.

The electric valve 208 is connected to the power line 207 via the PLC modem 211 and receives a control instruction and process data superimposed on the power line 207 from the control device 203 or other control apparatus and measurement apparatus. Moreover, the process I/O circuit 235 inputs signals such as a flow rate, a valve open degree, and a limit switch as process data associated with the electric valve from the electric valve body 224. The nonvolatile flash memory contains a protection interlock or a control logic associated with the electric valve. The MPU 232 operates a control instruction according to a control instruction from the control device 203 inputted via the PLC modem 211 and the interface 231, process data from other control and measurement apparatus, information obtained from the process I/O circuit 235, and the logic stored in the flash memory 234, and outputs the control instruction to the electric valve body 224 via the process I/O circuit 235. When heavy current is required for driving the electric valve body 224, the interface circuit 236 converts the weak current output of the process I/O circuit 235 to an electric signal required for driving the electric valve body 224. The interface circuit 236 is formed by an element such as a photo MOS relay and an auxiliary relay in a case of digital signal conversion, and by an isolator and a current amplifier in a case of analog signal conversion.

Moreover, the MPU 232 inputs process data associated with the electric valve from the electric valve body 224 via the interface circuit 236 and the process I/O circuit 235 and performs a conversion process according to the internal variable stored in the flash memory 234. The process data processed by the MPU 232 is superimposed on the power line 207 by the PLC modem 211 via the interface 231 and outputted to the control device 203 or other control apparatus or measurement apparatus.

The logic stored in the flash memory 234 includes a logic used when the power line communication with the control device 203 is disconnected or the logic used when no condition can be inputted from the other control apparatus or the measurement apparatus. For example, if the power line communication with the control device 203 is disconnected for a certain time, the logic operates so that an instruction value from the control device 203 is held. Alternatively, if no process data is inputted from other control and measurement apparatus, the logic defines so that the data inputted immediately before is held for performing an operation process. Thus, even if the power line communication is disconnected, it is possible to prevent a control-disabled state of the control apparatuses and continue the operation of the plant.

The other control apparatuses such as the pump 210 may have substantially identical configuration as the electric valve 208. The similar configuration can be obtained only by replacing the electric valve body 224 by the pump body (pump and electromagnetic contact).

Next, referring to FIG. 6, explanation will be given on the configuration of the measurement apparatus. FIG. 6 shows the internal configuration of the measurement unit 209. The measuring unit 9 includes a PLC modem 212, an operation circuit 222, and a sensor 225. The operation circuit 222 is almost identical to the operation circuit 221 of the electric valve 208. The operation circuit 222 is formed by an interface 241 performing a data I/O process, an MPU 242 performing an operation such as a measurement value conversion and correction, a RAM 243, a flash memory 244, and a process I/O circuit (PI/O) 245 which are connected by a BUS 247. Among these components, the process I/O circuit 245 performs only input from the sensor 225 and performs no output to the sensor 225. Moreover, the measurement unit 209 does not have the interface circuit which is present in the control apparatus. The operation circuit 222 is packaged and can easily be mounted on an installed sensor.

The MPU 242 can perform operations such as a sensor measurement value engineering value conversion and a temperature/pressure correction. Its operation program is stored in a nonvolatile flash memory 244. The MPU 242 subjects the sensor measurement value inputted from the process I/O circuit 245 to an operation process according to the operation program stored in the flash memory 244 and transmits the operation result to the control device 203 or other control apparatuses 208 and 210 by superimposing the result on power cable by the PLC modem 212.

Thus, in this embodiment when the control device 203 outputs a control instruction, the instruction is transmitted via the PLC modem 206 of the control device 203 to the control and measurement apparatuses 208 to 210 to be operated, by the power line communication. Accordingly, the control device 203 need not be connected to the control apparatuses and the measurement apparatus 208 to 210 by a cable other the power line.

Moreover, each of the control apparatuses (electric valve, pump, actuator, and the like) has a built-in control logic and can autonomously obtain an external condition required for operation without using the control device 203. Accordingly, instructions passed between the control device 203 and the respective control apparatuses are normally only instructions of start, stop, or control amount adjustment. For this, even if the power line communication between the control device 203 and the respective control apparatuses is disconnected, this will not cause a trouble for operation. Especially when the plant is performing a constant operation, it is possible to continue a stable operation for a certain time. Furthermore, the control apparatus can have a built-in protection logic to be used when the power line communication between the control device 203 and other control apparatus and measurement apparatus is disconnected. Accordingly, even when the power line communication is partially disconnected, this will no cause a trouble in the control apparatus or failure in the plant.

Next, explanation will be given on the protection interlock or a control logic built in the control apparatus according to the embodiment and the maintenance method of the operation program such ass a conversion process built in the measurement apparatus.

As shown in FIG. 4, in this embodiment, a maintenance device 227 having a built-in maintenance function in a personal computer or a computer of a mobile information terminal is connected to the power line 207 via the PLC modem 228 and a power line communication with the control and the measurement apparatus to be subjected to maintenance is performed via the PLC modem 228 so as to modify information such as the control logic and the internal parameter. The maintenance device 227 may be installed at a location where connection can be made with the power line 207. Accordingly, a maintenance staff can perform a maintenance work at a place where maintenance work can easily be performed such as a control apparatus room or at a place in the vicinity of the control and the measurement apparatus in the site. Here, the maintenance device 227 may be configured in such a manner that only data is acquired from the power line 207 and power required for operating the maintenance device 227 is acquired from a battery or other power source.

The maintenance device 227 includes a protection interlock or a control logic built in the control apparatus such the electric valve 208 and the pump 210 and operation programs such as an engineering value conversion and temperature/pressure correction built in the measurement apparatus such as the measurement unit 209. During a maintenance, the maintenance device 227 modifies a logic, an operation program, and a parameter of the apparatus requiring modification and transmits the modification content to an object apparatus by the PLC modem 228 while superimposing it on the power line so as to rewrite the content of the flash memory in the operation circuit of the object apparatus. Moreover, by providing a logic of the control and the measurement apparatus, a tuning function of an internal parameter used for operation, and a data simulation function in the maintenance device 227, it is possible to perform work such as an internal parameter tuning and a data simulation via the pLC modem 228.

Thus, in this embodiment, the protection interlock or the control logic, and an operation program associated with the measurement value correction are distributed in the operation circuit arranged in the control and the measurement apparatus but the maintenance can be performed all at once by the maintenance device. Moreover, since the maintenance device need not be fixedly installed, it is possible to perform the maintenance work when necessary at an arbitrary place capable of communication.

Next, explanation will be given on the power line communication process of the control device and the control and the measurement apparatus. The control device and the control and the measurement apparatus in this embodiment have a function for receiving and transmitting data not required for their logic operations in addition to the data inputted and outputted by themselves.

Explanation will be given on an example of the power line communication process in this embodiment. In this embodiment, a plurality of sets of the control device are installed for each control system. One of the control devices performs power line communication with a plurality of control and measurement apparatuses monitored and controlled by the control device. Moreover, the control and the measurement apparatus perform the power line communication with the control device and also perform the power line communication with other control and measurement apparatus in the control system to which the apparatus belongs. In the power line communication process within one control system, a power line transmission field defining arrangement of all the transmission data is used for transmitting and receiving the entire power line transmission field during a power line communication between the control device and the control and the measurement apparatus. The transmission and reception process is performed by the interface performing I/O process of control information via the PLC modem. Upon data reception, the power line transmission field data is stored in the internal storage region of the interface provided in the operation circuit. Upon data transmission, predetermined data on the power line transmission field is rewritten and the entire transmission field is transmitted.

Thus, the power line transmission field is treated as a virtual common memory and all the nodes perform a transmission process by the autonomous distributed protocol for copying the virtual memory, thereby realizing sharing of the data.

Furthermore, in this embodiment, when adding a new control apparatus or a new measurement apparatus, it is possible to easily add the apparatus to the system without arranging a process I/O cable. A power line for supplying power to the control apparatus or the measurement apparatus added should be installed without fail but this power line can be used for information communication. Accordingly, no cable other than the power cable is required. Moreover, when the added new control apparatus uses the process data in the existing control apparatus or the measurement apparatus for an operation process or an interlock condition, the data can be obtained by performing a transmission process by the aforementioned autonomous distributed protocol without reforming the existing control apparatus or the measurement apparatus.

As has been described above, by performing the power line communication between the control device and the respective control apparatuses and the measurement apparatuses, no cable other than the power cable is required. This significantly reduces the number and the amount of cables and simplifies the device configuration. Moreover, each of the control apparatuses and the measurement apparatuses are made programmable and include the built-in protection interlock or the control logic so as to obtain an autonomous distributed type. Accordingly, even if the power line communication with the control device is disabled, it is possible to continue control without causing a disaster.

It should be further understood by those skilled in the art that although the foregoing description has been made on embodiments of the invention, the invention is not limited thereto and various changes and modifications may be made without departing from the spirit of the invention and the scope of the appended claims.

1. A control apparatus comprising:
a radio communication unit for performing a communication by radio between a control device and other control apparatus;
a state input unit for inputting process data indicating a state of the control apparatus and a measurement value indicating a plant state;
a radio control information I/O unit for inputting or outputting control information such as a control instruction and process data via the radio communication unit;
a storage unit for storing logic of a protection interlock or a control logic of the control apparatus;
an operation unit for operating a control signal according to logic of the protection interlock or the control logic stored in the storage unit, the control instruction inputted from the control device via the radio communication unit, and process data on the control apparatus and the other associated control apparatus; and
a control signal output unit for outputting the control signal operated by the operation unit.

2. The control apparatus as claimed in claim 1, wherein
the radio communication unit has a function for relaying the process data on the other process apparatus not used for the operation process of the protection interlock or the control logic of the control apparatus.

3. The control apparatus as claimed in claim 1, wherein
at least one of the state input unit, the radio control information I/O unit, the control signal output unit, and the operation unit is multiplexed.

4. The control apparatus as claimed in claim 1, wherein
logic of a protection interlock or control logic stored in the storage unit is made rewritable, and
maintenance is performed by modifying or updating the logic of the protection interlock or the control logic of the control apparatus according to an instruction from a maintenance device having radio communication unit performing radio communication with the control apparatus.

5. A monitoring control system in which a control device performs a radio communication with a plurality of control apparatuses for monitoring and controlling the apparatuses, wherein
each of the plurality of control apparatuses comprises:
a radio communication unit performing radio communication with the control device and the other control apparatus;
a state input unit for inputting process data indicating a state of the control apparatus and a measurement value indicating a state of a plant;
a radio control information I/O unit inputting or outputting control information such as a control instruction and process data via the radio communication unit;
a storage unit for storing logic of the protection interlock or the control logic of the control apparatus;
an operation unit for operating a control signal according to logic of the protection interlock or the control logic stored in the storage unit, the control instruction inputted from the control device via the radio communication unit, and process data on the control apparatus and the other associated control apparatus; and
a control signal output unit for outputting the control signal operated by the operation unit; and
the control device comprises:
a radio communication unit for inputting and outputting control information by radio with the plurality of control apparatuses; and
a processing unit for generating a control instruction for the control apparatuses, and monitoring and controlling the control apparatuses; and
the control device monitors and controls the plurality of control apparatuses for operating the plant.

6. A control method comprising:
a step of performing a communication by radio between a control device and other control apparatus;
a step of inputting process data indicating a state of the control apparatus and a measurement value indicating a plant state;
a step of inputting or outputting control information such as a control instruction and process data via the radio communication unit;
a step of operating a control signal according to logic of the protection interlock or the control logic stored in the storage unit, the control instruction inputted from the control device via the radio communication unit, and process data on the control apparatus and the other associated control apparatus; and
a step of outputting the control signal operated by the operation unit.

7. A control apparatus comprising:
a power line communication unit for performing communication with a control device and other control apparatus by superimposing a carrier on a power line;
a control information I/O unit for inputting or outputting control information such as a control instruction and process data via the power line communication unit;
a storage unit for storing logic of a protection interlock or a control logic of the control apparatus;
an operation unit for operating a control signal according to logic of the protection interlock or the control logic stored in the storage unit, the control instruction inputted from the control device via the power line communication unit, and process data on the control apparatus and the other associated control apparatus; and
a control signal output unit for outputting the control signal operated by the operation unit.

8. The control apparatus as claimed in claim 7, wherein
at least one of the state input unit, the control information I/O unit, the control signal output unit, and the operation unit is multiplexed.

9. The control apparatus as claimed in claim 7, wherein
logic of a protection interlock or control logic stored in the storage unit is made rewritable, and
maintenance is performed by modifying or updating the logic of the protection interlock or the control logic of the control apparatus according to an instruction from a maintenance device having power line communication unit performing communication by power line with the control apparatus.

10. A monitoring control system in which a control device performs a power line communication with a plurality of control apparatuses for monitoring and controlling the apparatuses, wherein
each of the plurality of control apparatuses comprises:
a power line communication unit performing radio communication with the control device and the other control apparatus by the power line while superimposing a carrier on the power line;
a state input unit for inputting process data indicating a state of the control apparatus and a measurement value indicating a state of a plant;
a control information I/O unit inputting or outputting control information such as a control instruction and process data via the radio communication unit;
a storage unit for storing logic of the protection interlock or the control logic of the control apparatus;
an operation unit for operating a control signal according to logic of the protection interlock or the control logic stored in the storage unit, the control instruction inputted from the control device via the power line communication unit, and process data on the control apparatus and the other associated control apparatus; and
a control signal output unit for outputting the control signal operated by the operation unit; and
the control device comprises:
a power line communication unit for inputting and outputting control information with the plurality of control apparatuses by a power line; and
a processing unit for generating a control instruction for the control apparatuses, and monitoring and controlling the control apparatuses; and
the control device monitors and controls the plurality of control apparatuses for operating the plant.

11. A control method comprising:
a step of performing a communication between a control device and other control apparatus by superimposing a carrier on a power line;
a step of inputting process data indicating a state of the control apparatus and a measurement value indicating a plant state;
a step of inputting or outputting control information such as a control instruction and process data via the power line communication unit;
a step of operating a control signal according to logic of the protection interlock or the control logic stored in the storage unit, the control instruction inputted from the control device via the power line communication unit, and process data on the control apparatus and the other associated control apparatus; and
a step of outputting the control signal operated by the operation unit.
